(19) United States
(12) Patent Application Publication
(10) Pub. No.: US 2023/0010471 A1
(43) Pub. Date: Jan. 12, 2023

(54) INTEGRATED SENSOR CONNECTION

(71) Applicant: VALLOUREC OIL AND GAS FRANCE, Aulnoye-aymeries (FR)

(72) Inventor: Eric VERGER, Meudon (FR)

(73) Assignee: VALLOUREC OIL AND GAS FRANCE, Aulnoye-aymeries (FR)

(21) Appl. No.: 17/785,350

(22) PCT Filed: Dec. 9, 2020
(86) PCT No.: PCT/FR2020/052360

§ 371 Date: Jun. 14, 2022

(30) Foreign Application Priority Data
Dec. 20, 2019 (FR) FR1915190

(51) Int. Cl. E21B 47/06; E21B 17/042

(52) U.S. Cl. CPC E21B 47/06; E21B 17/042

(57) ABSTRACT

A male or female tubular threaded connection for a steel pipe includes at least one external or internal threading, an end lip, a portion produced by additive manufacturing arranged to house at least one sensor at a predetermined distance from a functional surface of said connection, the sensor being arranged to measure a physical quantity related to said functional surface and said functional surface being selected from a sealing surface, a threading, an abutment, an internal diameter or an external diameter.

The invention relates to tubular threaded components and more particularly to steel tubular connections for a tubular threaded joint for drilling, operating hydrocarbon wells or for transporting oil and gas or for geothermal wells, or else for CO₂ storage wells.

The term “component” means here any element or accessory used to drill or operate a well and comprising at least one connection or connector or else a threaded end, and intended to be assembled by a threading to another component in order to constitute with this other component a tubular threaded joint. The component can be for example a tubular element of relatively great length (in particular about ten metres in length), for example a tube, or else a tubular sleeve of a few tens of centimetres in length, or else an accessory of these tubular elements (suspension device or “hanger”, section changing part or “cross-over”, safety valve, connector for drill rod or “tool joint”, “sub”, and the like).

The tubular components have threaded ends. These threaded ends are complementary allowing the coupling of two male (“Pin”) and female (“Box”) tubular elements together, forming a joint. There is therefore a male threaded end and a female threaded end. The threaded ends called premium or semi-premium threaded ends generally include at least one abutment surface. A first abutment may be formed by two free surfaces on the threaded ends configured so as to be in contact with one another after the threaded ends are screwed together or during compressive biases. Abutments generally have negative angles relative to the main axis of the connections.

These joints are subjected to axial tensile or compressive biases, internal or external fluid pressures, bending or else torsion, possibly combined and of intensity which may fluctuate. Sealing must be ensured despite the biases and the harsh conditions of use on site. The threaded joints must be able to be screwed and unscrewed several times without degrading their performance, in particular by seizure. After unscrewing, the tubular components can be reused under other operating conditions.

In particular, seizure is a phenomenon that can occur when assembling connections. The occurrence of seizure can be identified during screwing, in particular thanks to abnormal variations in the speed or the screwing torque applied during assembly, but any seizure is not necessarily detected by these parameters alone, the assembly being able to appear as normal with the existing means of measurement. In addition, the location of a seizure cannot be determined with these parameters alone. Seizure can result in localised tearing of material. For example, a tearing of material within the threads, or else a tearing of material at the sealing surfaces. It is then understood that the main functions of the threads or sealing surfaces can be compromised. There is therefore a need for additional solutions to improve the reliability of detecting the occurrence of seizure during assembly.

Furthermore, another form of degradation of the functional elements of a connection can be unwanted plastifications of material, following biases undergone higher than the biases of use under normal conditions, or following repetitions of biases, including in standard fields of use for the connection. Still further, fatigue biases can degrade the state of the functional elements of a connection, by causing fatigue cracks to appear in the material.

There is therefore a need for a solution allowing to determine the state conditions of the connections during their assembly or during their use.

The present invention allows the situation to be improved.

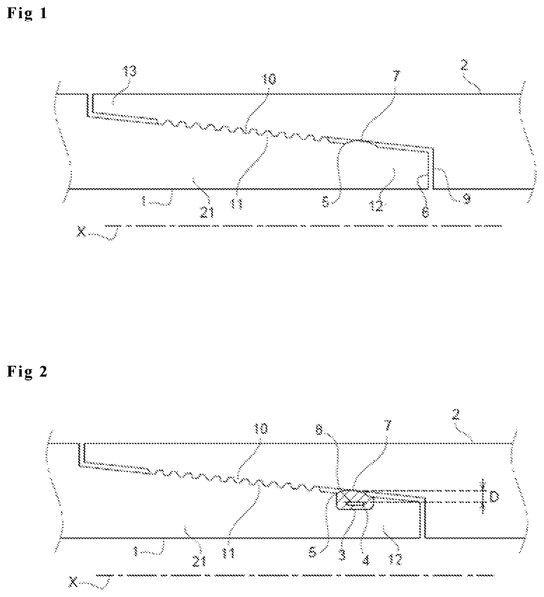

FIG. 1 shows, in partial sectional view, a connection of the prior art.

FIG. 2 shows a connection according to a first variation of the invention.

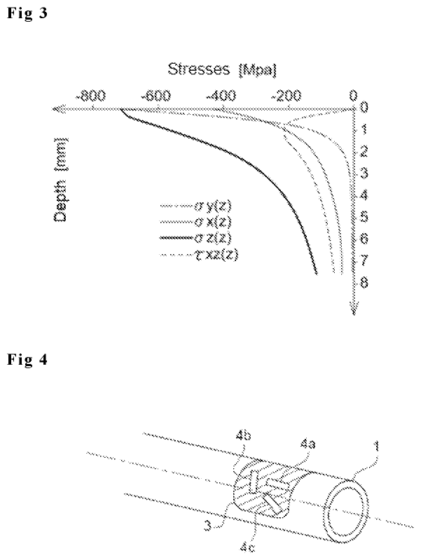

FIG. 3 shows a graph of the distribution of the stress components as a function of the depth in line with a sealing surface for a given connection.

FIG. 4 shows a schematic perspective view of a variation of the invention.

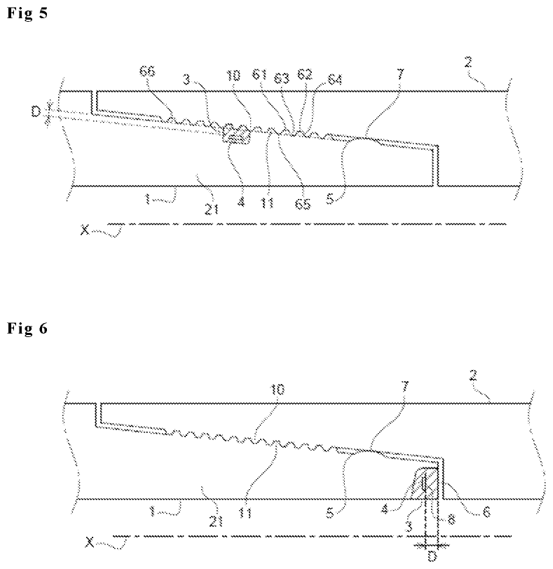

FIG. 5 shows a connection according to a second variation of the invention.

FIG. 6 shows a connection according to a third variation of the invention.

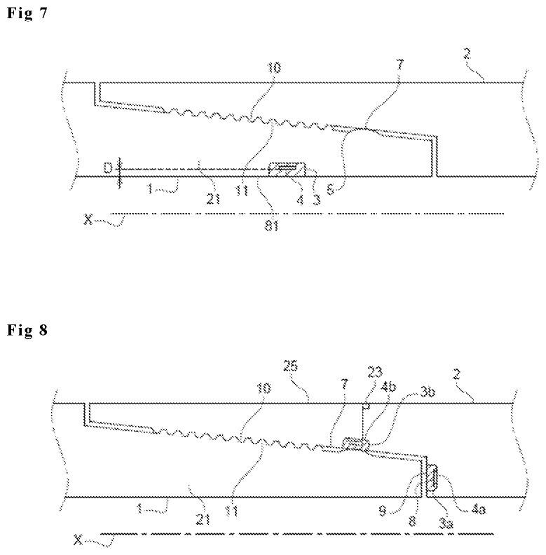

FIG. 7 shows a connection according to a fourth variation of the invention.

FIG. 8 shows a connection according to a fifth variation of the invention.

According to a first aspect, the invention is a male or female tubular threaded connection (1) for a steel pipe comprising at least one external (10) or internal (11) threading, an end lip (12), a portion produced by additive manufacturing (3) arranged to house at least one sensor (4) at a predetermined distance from a functional surface (5, 6, 7) of said connection, the sensor (4) being arranged to measure a physical quantity related to said functional surface (5, 6, 7) and said functional surface (5, 6, 7) being selected from a sealing surface, a threading, an abutment, an internal diameter or an external diameter. This allows to have at least one sensor in the connection and to be able to access measurements of the physical conditions of the connection.

According to one aspect, the at least one sensor (4) can comprise a transducer selected from a strain gauge, a shear gauge, a rosette-type strain gauge, a force sensor, a temperature gauge, a pressure sensor, or a threshold detector. This allows the physical conditions of stresses and temperatures within a connection to be accessed, which are quantities allowing access to the states of the connection, whether biased, in fatigue, in conditions of use.

According to another aspect, the connection can comprise a thermal protection plate (8) near said at least one sensor (4) and located between the at least one sensor (4) and the portion added by additive manufacturing (3). This allows the sensor and its associated electronics to be protected during the manufacture of the connection and the addition of additive material, and also allows the measurements of said sensors to be improved.

The sensor (4) can be at a distance D greater than or equal to a minimum depth P min such that:

$$Pmin = 5.031 \times \sqrt{\frac{160 \times e \times intf \times R \times ( 1 - {υ}^{2} )}{π \times {D}^{2}}}$$

According to a variant, the functional surface can be a sealing surface (5) and the sensor (4) is located in line with the sealing surface (5) at a radial distance of at least 0.6 mm from the sealing surface (5). This allows in particular physical quantities related to the sealing surface (5) to be measured.

According to another variant, said sensor (4) is selected from a strain gauge, a shear gauge, a rosette-type strain gauge, a force sensor, and said sensor (4) is located in line with a sealing surface (5) and at a radial distance of at least 2×P min from the sealing surface (5). This allows the stresses in the connection representative of the stresses undergone by the sealing surface (5) to be reliably measured.

According to a complementary or alternative variant, the functional surface can be an external (10) or internal (11) threading and the sensor (4) is located in line with said external (10) or internal (11) threading at a distance greater than or equal to P min relative to a threading root line. This allows the stresses in the connection representative of the stresses undergone by the threading (10, 11) to be reliably measured.

According to a complementary or alternative variant, the functional surface can be an external (10) or internal (11) threading and the sensor (4) can be located in line with said external (10) or internal (11) threading at a distance greater than or equal to 0.6 mm relative to a threading root line.

According to a complementary or alternative variant, the functional surface can be an internal diameter (Di) and the sensor (4) can be located in line with the internal diameter (Di) and at a radial distance of at least 0.6 mm from the internal surface (5). This allows the stresses in the connection representative of the stresses undergone by the internal surface (5) to be reliably measured.

According to a complementary or alternative variant, the functional surface can be an abutment surface (6) and the sensor is located at a distance D of at least 1 mm from the abutment surface. This allows the stresses in the connection representative of the stresses undergone by the abutment (6) to be reliably measured and the sensor to be protected from the high mechanical stresses which are usually exerted on an abutment.

According to one aspect, the added portion (11) can be produced by a method selected from recharging methods, electron beam melting methods, metal powder bed laser melting or “selective laser melting” methods, selective laser sintering methods, direct metal deposition or “Direct Energy Deposition” methods, Binder Projection Deposition or Laser projection deposition methods, arc-wire additive manufacturing deposition methods.

The invention is also a method for producing a threaded connection (1) for a steel pipe comprising the steps of:
First machining of a connection body forming a housing,
Mounting of at least one sensor in said housing, optionally with at least one thermal protection plate,
Material deposition by additive manufacturing so as to complete said housing over the at least one sensor (4) and optionally over the thermal protection plate (8) and thus produce a portion by additive manufacturing,
Complementary machining of the connection comprising the machining of a functional surface in said portion carried out by additive manufacturing.

The invention will be better understood using the description and the appended drawings.

FIG. 1 shows a partial sectional view of a female connection (2) and a male connection (1) of the prior art comprising respectively an internal threading (10) and an external threading (11), a female sealing surface (7) and a male sealing surface (5), a male end lip (12) comprising a male abutment (6); a corresponding female abutment (9) on the female connection (2).

The connections may also comprise several threading stages, additional sealing surfaces, for example located between the female end lip (13) and a threading (10, 11), with a corresponding sealing surface on the male element (1).

The embodiments described below describe a male connection but the features described also apply to a female connection.

FIG. 2 shows a first embodiment of the invention wherein a male connection (1) comprises a body (21), a threading (11), an end lip (12), a portion produced by additive manufacturing (3), and a sensor (4).

The sensor (4) comprises a transducer for converting a physical signal into another signal, particularly an electrical signal.

The portion produced by additive manufacturing (3) comprises a sealing surface (5). The sensor (4) is located at a predetermined distance D from the sealing surface (5). The sensor (4) is arranged to measure a physical quantity related to said functional surface which is here a sealing surface. That is to say that the sensor is arranged to be able to measure physical quantities such as a stress, a temperature, a force, near said functional surface (5) and which are representative of quantities exerted at the functional surface (5).

According to one aspect, the connection comprises a thermal protection plate (8), located near the sensor (4) and arranged to separate the transducer of the sensor (4) from a part of the portion added by additive manufacturing (3). The thermal protection plate allows the sensor to be protected from damage due to heat during the step of producing the part added by additive manufacturing, a method which is exothermic.

Advantageously, the protection plate (8) is arranged so as to limit the loss of bias transmission at the external surface near the sensor (4). In the case of the first embodiment, the surface near the sensor is the sealing surface (5). The protection plate is therefore arranged so as to be able to transmit the stresses exerted at the sealing surface (5) and transmitted into the material near said sealing surface (5). The sensor (4) and the thermal protection plate (8) can be linked by gluing, screwing, punching, the transducer can be printed, for example on an epoxy plate. In practice, the thermal protection plate is a substantially flat plate. It may include bent or curved ends so that the thermal protection plate has an inverted U profile or an H profile, in order to laterally protect the transducer of the sensor (4) and/or in order to improve the hanging of the protection plate in the connection.

According to one aspect, the transducer of the sensor (4) is selected from a strain gauge, shear gauge, a rosette-type strain gauge, a force sensor, a temperature gauge, a pressure sensor, a threshold detector.

By way of example, the transducer of the sensor (4) may be a piezo-resistive stress gauge of the film-frame gauge type, made of a printed circuit on an epoxy support plate screwed onto the protection plate. Alternatively, the gauge can be a wire gauge glued on a support plate. Alternatively, the sensor can be soldered or printed.

Advantageously, the support plate is the thermal protection plate (4). The addition of material by additive manufacturing is done on the thermal protection plate, so that the closeness between the thermal protection plate and the added material allows stresses to be transmitted from the added material to the thermal protection plate.

The thermal protection plate may have a thickness greater than 0.3 mm. The thermal protection plate can be made of steel, stainless steel or titanium alloy, copper and/or aluminium alloy. The thermal protection plate can be a combination of two layers, a layer of steel or stainless steel or titanium alloy and a layer of copper and/or aluminium alloy, or a layer of low thermal conductivity to stop the propagation of the heat and a layer of high thermal conductivity to dissipate the heat.

According to another aspect, the sensor (4) can be of the integrated type. An integrated sensor comprises, in addition to a transducer of a physical component into an electrical signal or measurement signal, an electronics arranged to shape said measurement signal into an output measurement signal, optionally a memory module and a communication module to store the measurements made in the form of data sets and to communicate the measurement data upon request from an external control unit. The sensor may further comprise a power source.

In the first embodiment of FIG. 2, a sensor (4) is located in line with the sealing surface (5). The sensor (4) is located at a distance D of at least 0.6 mm from the sealing surface (5).

More generally, when the sensor (4) is selected from stress or force sensors, such as a strain gauge, shear gauge, a rosette-type strain gauge, a force sensor, a pressure sensor, a threshold detector, it is preferable that said sensor (4) is located at a minimum distance from a sealing surface, a distance D greater than or equal to the depth P min such that

$$Pmin = 5.031 \times \sqrt{\frac{160 \times e \times intf \times R \times ( 1 - {υ}^{2} )}{π \times {D}^{2}}} \qquad ( 1 )$$

This equation (1) is applicable to a toroidal or torus-cone type sealing surface, that is to say a metal-to-metal seal, one of the surfaces of which has a radius of curvature R.

This minimum distance P min depends on the diameter of the sealing surface D, the interference intf, the thickness e of the lip supporting the sealing surface, the radius R of the toroidal portion as well as the Poisson's ratio of the material. The multiplier coefficient 5.031 is applied. This coefficient corresponds to the half-length of contact which, multiplied by 0.7861, allows the depth for which the shear stress is maximum to be calculated, that is to say (12.8/2)×0.7861≈5.031. The number 0.7861 corresponds to the coefficient of the theory of Hertz in the context of a linear contact.

Beyond the depth P min, the variation in value of the stresses is said to be stabilised, without inflection of the variation in values. In addition, the presence of the sensor may involve a redistribution of stresses in the material due to a discontinuity, even if this effect remains punctual relative to the circumference of the sealing surface.

Nevertheless, it has been determined that a minimum distance of 0.6 mm of the sensor from the stressed surface allows in most cases to avoid abrupt variations in stresses and further allows the effects of redistribution of stresses to be limited. The sensor is located at a distance of at most 5 mm from the sealing surface (5), in order to ensure that the sensor (4) can measure stresses representative of a contact state of the sealing surface, in particular contact with a corresponding sealing surface of a female connection.

The connection can include more than one sensor, preferably distributed circumferentially. The sensors can be of the same type or of different types. In addition or alternatively, the connection may include more than one sensor, all contained in the same portion produced by additive manufacturing (3).

For example, the tubular threaded connection (1) of FIG. 4 comprises three sensors (4a, 4b, 4c). The three sensors (4a, 4b, 4c) are stress gauges. A stress gauge has an orientation called longitudinal orientation. The three sensors (4a, 4b, 4c) are disposed so as to measure three components of the stress undergone by the connection: a normal axial stress gauge (4a), the longitudinal orientation of which is substantially parallel to the axis of the connection; a normal circular stress gauge (called “hoop stress”) (4b), the longitudinal orientation of which is substantially perpendicular to the axis of the connection; a shear gauge (4c), the longitudinal orientation of which forms an angle of 45° with a straight line parallel to the axis of the connection and passing through a point on the gauge.

This example is non-limiting relative to the addition of additional sensors, for example of a different nature, such as a temperature gauge, a force sensor. Also, for example, the stress sensors can be of different types. It is possible to replace a stress gauge with another one of the rosette type, or a shear gauge. Advantageously, the temperature gauge allows the operating temperature of the sensor to be known and the temperature data can be used to perform a corrective calculation for the stresses measured by one or more stress gauges.

Alternatively, for a stress gauge type sensor, the stress gauge can be produced by means of additive manufacturing methods, by means of printing layers which are successively electrically non-conductive and electrically conductive and arranged with patterns allowing electrically conductive and insulated tracks to be achieved. Typically, the conductive tracks have shapes of network, comb, rosette bridge type, namely the conventional shapes of stress gauges.

In a connection variation including several circumferentially distributed sensors, a connection according to the invention may comprise a circular groove wherein a sensor belt is placed, which groove is then completed by a deposition of material produced by additive manufacturing.

A sensor (4) can comprise a processing electronics connected to the transducer of the sensor (4). The processing electronics can comprise a signal conditioning stage, which may comprise a converter sub-stage, an amplifier sub-stage, and a filter sub-stage. The processing electronics may comprise a memory arranged to store the measurement data. Thus, the sensor (4) can be interrogated by an external device to record the measurements made during a period of time.

In one variation, the sensor (4) may be provided with a circuit arranged to count the number of cycles during which a measured stress intensity has exceeded a predetermined stress threshold intensity. Thus, the sensor can record the number of cycles undergone by the connection at the monitored functional surface.

The processing electronics can be connected by a conductor or by an emitter allowing a wireless measurement signal to be transmitted to a control unit. This control unit is arranged to transmit, process or display the measured quantity.

FIG. 3 is a graph showing curves corresponding to the stress components in the material, as a function of the depth and in line with a sealing face, for a connection of the prior art. The ordinate corresponds to the depth in mm from the sealing surface. The abscissa represents the stress values in Mpa. It is noted that the variations of stresses decrease strongly beyond a depth of 1 mm and also that the evolutions of stresses are stabilised, that is to say without inflection of the curve, as is the case for the curve of the values of shear stresses around 1 mm distance from the sealing surface. Thus, it is more interesting to introduce a discontinuity in the material from a distance of 1 mm from the sealing surface in the case of this connection. Calculations have shown that a minimum depth of 0.6 mm was indicated for most connections. It is also possible to use the calculation of the minimum depth P min according to the mentioned equation (1).

Preferably, the sensor (4) can be at a distance of at most 5 mm from the monitored functional surface, because beyond that, some components of physical quantities to be measured, such as the stresses, may no longer be able to be measured effectively or so as to be able to reliably find the corresponding representative quantities at the surface of the object.

Thus, a sensor (4) can be arranged to measure stresses, forces or temperatures exerted at a sealing surface, for example to measure torsional stresses at the sealing surface. Indeed, the sensor having a given orientation, therefore a known stress component, a predetermined distance from the sealing surface whose geometry is known, it is possible to determine a stress exerted at the sealing surface (5) from a stress measured by the sensor (4).

### Threading

According to a second embodiment shown in FIG. 5, the connection comprises a portion produced by additive manufacturing (3), a sensor (4) located at a predetermined distance from an external threading (10) or internal threading (11), depending on whether the connection is respectively a male or female connection, the sensor (4) being arranged to measure a physical quantity related to the internal or external threading. An external (10) or internal (11) threading comprises, in a side view as shown in FIG. 5, a series of threads (61) comprising crests (62), roots (63) of the engagement flanks (64) and loading flanks (65). The thread roots (63) seen in a section plane are virtually connected by a threading root line (66) which is a virtual line joining the thread roots of the threading. The sensor (4) is located at a distance of at least 0.6 mm from the threading root line. Preferably, the sensor (4) is located at a distance of at most 5 mm from the threading root line. Distance here refers to the distance from a point to a straight line and therefore corresponds to the shortest distance between a point and a point running on the straight line, that is to say the shortest distance between the sensor and a point on the thread root line of the threading.

A connection including multiple threading stages may have a threading root line if the thread stages are aligned, or each have its threading root line when the thread stages are not aligned.

Thus, a sensor (4) can be arranged to measure stresses, forces or temperatures exerted in the threading, for example to measure shear stresses at the base of the teeth of the threading. Indeed, the sensor having a given orientation, therefore a known stress component, a predetermined distance from the base of a tooth of the threading, and the geometry of the teeth being known, it is possible to determine a stress exerted at the base of the tooth of the threading considered from a stress measured by the sensor (4).

### Abutment

According to a third embodiment shown in FIG. 6, the connection comprises a portion produced by additive manufacturing (3), a sensor (4) and an abutment surface (6), the sensor (4) being located at a predetermined distance from the abutment surface (6) and arranged to measure a physical quantity related to the abutment surface (6). Preferably, the sensor (4) is at a substantially axial distance D of at least 1 mm from the abutment surface (6) and at most 7 mm. The distance from the sensor to the abutment surface is generally greater than for other functional surfaces because the forces involved at one abutment surface are greater than for other functional surfaces.

Similarly to the other embodiments, measuring a stress at the sensor (4) allows a corresponding stress at the abutment surface to be determined. This allows, for example, cases of risk of plastification of the abutment to be detected, or else when the sensor is equipped with a memory and a counter of exceeding a predetermined threshold, the counting of the number of stress cycles of the abutment surface.

### Internal Diameter

According to a fourth embodiment shown in FIG. 7, the connection is a male connection and comprises a portion produced by additive manufacturing (3) arranged to house a sensor (4) and an internal surface (81), the sensor (4) is located at a predetermined distance from the internal surface (81) and arranged to measure a physical quantity related to the internal surface (81). The portion produced by additive manufacturing separates the sensor (4) from the internal surface (81). The portion produced by additive manufacturing comprises part of the internal surface (81). Preferably, the sensor (4) is at a substantially radial distance D of at least 0.6 mm from the internal surface, in order to protect the sensor (4) from wear which may occur in service on the internal surface (81). Preferably, the sensor (4) is at a distance less than or equal to 7 mm from the internal surface (81).

All the four embodiments are not mutually exclusive, they can perfectly be combined one by one or all together.

FIG. 8 shows a variation combining several described embodiments, with a joint wherein the female connection 2 comprises two areas added by additive manufacturing (3a, 3b) arranged to house two sensors (4a, 4b) respectively placed at a predetermined distance from a female abutment surface (9) and from a sealing surface (7). The sensor (4b) near the sealing surface (7) is connected to a processing electronics (22) and a transmission electronics (23) located near the external surface (25).

According to another aspect of the invention, the sensor (4) can be connected to a processing electronics (22) and/or a transmission electronics (23). These processing and/or transmission electronics (22, 23) can be disposed near the sensor(s); these electronics can be installed in the same casing with an integrated sensor.

When at least part of these electronics (22, 23) is located at a distance from the sensor(s) (4), the connection may comprise electrically conductive tracks, particularly insulated conductive wires positioned in fitted housings and one wall portion of which is produced by additive manufacturing. These conductors can preferably open near an imperfect thread, or near a grease pocket, or onto an internal surface in the case of a male connection, or an external surface in the case of a female connection or a sleeve. These arrangements are subjected to less mechanical biases than perfect threads, sealing surfaces or abutments.

### Electronics

A processing electronics (22) comprises a circuit arranged to receive at the input an electrical signal coming from the sensor and to emit at the output a signal representative of the quantity measured by the sensor modified by a transformation factor k. This transformation factor k can be predetermined so as to take into account the position of the sensor, its depth or distance from the targeted functional surface, the presence of additional elements such as a protective plate (8), the latter can introduce a discontinuity in the material and disturb the distribution of mechanical stresses or temperatures in the volume of the part. The transformation factor k can be linear. The transformation factor can be nonlinear. Preferably, the transformation factor is determined by a calibration performed on the basis of a connection model, a sensor configuration and implantation of said sensor. With a sufficient implantation depth, the variation in stress values as a function of depth is smaller and allows good repeatability of measurements to be obtained from a connection equipped with a sensor to another having the same configuration. It is therefore possible to calibrate the sensor and the processing electronics (22) from a standard model.

### Obtaining Method

According to one aspect, the invention is also a method for obtaining a connection equipped with at least one sensor wherein a first machining of a tubular element is carried out, by milling or turning.

The first machining can be a housing, in the shape of a recess or a groove made from a tubular element obtained after drilling thereof, or after an optional tapering step, which is designated by the term connection body.

Then a second mounting step comprises the actions of installing one or more sensors (4), optionally disposed near one or more thermal protection plates.

A third step is to dispose material by additive manufacturing over the sensor(s) (4) and so as to fill the recess or the machined groove. In the case of a circumferential groove, the deposition of material by additive manufacturing can be done with a non-rotating print head and a rotating tube.

A fourth step comprises the complementary machining of the connection to produce a functional surface at least part of the machining of which is done in the material added by additive manufacturing, the functional surface being selected from a sealing face, an abutment, an internal or external surface, a threading.

1. A male or female tubular threaded connection for a steel pipe comprising at least one external or internal threading, an end lip, a portion produced by additive manufacturing arranged to house at least one sensor at a predetermined distance from a functional surface of said connection, the sensor being arranged to measure a physical quantity related to said functional surface and said functional surface being selected from a sealing surface, a threading, an abutment, an internal diameter or an external diameter.

2. The threaded connection according to claim 1, wherein the at least one sensor comprises a transducer selected from a strain gauge, a shear gauge, a rosette-type strain gauge, a force sensor, a temperature gauge, a pressure sensor, or a threshold detector.

3. The threaded connection according to claim 1, comprising a thermal protection plate near said at least one sensor and located between the at least one sensor and the portion added by additive manufacturing.

4. The threaded connection according to claim 1, wherein the sensor is at a distance D greater than or equal to a minimum depth P min such that:
$$Pmin = 5.031 \times \sqrt{\frac{160 \times e \times intf \times R \times ( 1 - {υ}^{2} )}{π \times {D}^{2}}} .$$

5. The threaded connection according to claim 1, wherein the functional surface is a sealing surface and the sensor is located in line with the sealing surface at a radial distance of at least 0.6 mm from the sealing surface.

6. The threaded connection according to claim 1, wherein said sensor is selected from a strain gauge, a shear gauge, a rosette-type strain gauge, a force sensor, and said sensor is located in line with a sealing surface and at a radial distance of at least 2×P min from the sealing surface.

7. The threaded connection according to claim 1, wherein the functional surface is an external or internal threading and the sensor is located in line with said external or internal threading at a distance greater than or equal to P min relative to a threading root line.

8. The threaded connection according to claim 1, wherein the functional surface is an external or internal threading and the sensor is located in line with said external or internal threading at a distance greater than or equal to 0.6 mm relative to a threading root line.

9. The threaded connection according to claim 1, wherein the functional surface is an internal diameter and the sensor is located in line with the internal diameter and at a radial distance of at least 0.6 mm from the internal surface.

10. The threaded connection according to claim 1, wherein the functional surface is an abutment surface and the sensor is located at a distance D of at least 1 mm from the abutment surface.

11. The threaded connection according to claim 1, wherein the added part is produced by a method selected from recharging methods, electron beam melting methods, metal powder bed laser melting or “selective laser melting” methods, selective laser sintering methods, direct metal deposition or “Direct Energy Deposition” methods, Binder Projection Deposition or Laser Projection Deposition methods, arc-wire additive manufacturing deposition methods.

12. A method for producing a threaded connection for a steel pipe comprising the steps of:
first machining of a connection body forming a housing,
mounting of at least one sensor in said housing, optionally with at least one thermal protection plate,
material deposition by additive manufacturing so as to complete said housing over the at least one sensor and optionally over the thermal protection plate and thus produce a portion by additive manufacturing,
complementary machining of the connection comprising the machining of a functional surface in said portion carried out by additive manufacturing.
